(19) United States
(12) Patent Application Publication
(10) Pub. No.: US 2009/0189740 A1
(43) Pub. Date: Jul. 30, 2009

(54) METHOD AND SYSTEM FOR DETECTING VITAL SIGNS OF LIVING BODIES

(76) Inventor: ANATOL WIESNER, Berlin (DE)

Correspondence Address: MICHAEL RIES, 318 PARKER PLACE, OSWEGO, IL, 60543, US

(21) Appl. No.: 12/361,975

(22) Filed: Jan. 29, 2009

Related U.S. Application Data
(60) Provisional application No. 61/024,546, filed on Jan. 29, 2008.

(51) Int. Cl. H04Q 5/22

(52) U.S. Cl. 340/10.3

(57) ABSTRACT

Method and system for detecting vital signs of living bodies in particular in visually obstructed areas by means of illuminating the area of interest with interrogating multifrequency electromagnetic signal. The reflected energy is phase demodulated in quadrature separately on every frequency and analyzed on presence of respiration and heartbeat signature, whereby pairs of frequencies with the same relationship of quadrature components are used for ranging. A system for detecting vital sings of living bodies includes a means of generating said interrogating signal, a transmit antenna, a receive antenna, a multichannel quadrature mixer and multichannel FFT analyzer. The quadrature components so obtained can be processed jointly or separately and monitored on a multistrip waterfall diagram or as a multichannel spectrum plot.

This application claims priority to U.S. Provisional Application 61024546 filed 29 Jan. 2008, the entire disclosure of which is incorporated by reference.

### BACKGROUND OF THE INVENTION

This invention relates in general to the use of interaction between electromagnetic radiation and a living body to detect its presence within the region of interest, and in particular to the use of radar techniques to detect a living body and to evaluate the distance to a living body in visually obstructed areas thru extracting respiration and heartbeat signature from reflected interrogation radio frequency signal.

The use of interaction between electromagnetic field and human body to detect its presence within area of interest is known in prior art at least since Leon Theremin disclosed Signalling Apparatus in German Patent No. 449075 in 1924, and the use of radiated electromagnetic radiation to detect a living body thru extracting information on its breathing and heartbeat is known at least since Lipkin et al disclosed a microwave respiration monitor at Carnahan Conference on Crime and Countermeasures in 1979.

Continuous wave vital signs detection systems are still attractive for many applications because of their minimal radio frequency spectrum requirements resulting from narrow band nature of their interrogating signal, their very high sensitivity, moderate level of radiated RF power and ease of technical implementation.

In the prior art the patent to Sharpe at al., U.S. Pat. No 4,958,638 discloses non-contact vital signs monitor which, apart from medical use, can be used for detecting the presence of persons in visually obstructed areas or under the debris resulting from certain disasters. The disclosed method is based on a Linear Frequency Modulation (LFM) continuous wave (CW) technique and employs sophisticated signal processing of sidelobes of the reflected signal around original modulating ramp frequency. The method does disclose detection of living bodies and range discrimination, however, implementation of the method requires a broadband interrogating signal resulting from broad frequency deviation and reasonably high chirp rate necessary for detection and ranging process. Obtaining necessary interrogation signal bandwidth may be possible only on higher frequencies, specifically, 3 to 10 GHz as stated in patent Description. Signal penetration thru the obstacles can be fairly weak at higher frequencies, reducing obtainable operation range of the method. Apart, broadband character of the interrogation signal may lead to collisions with other systems and/or prevent from employing more than one radar on a site.

The patent to Schmidt, EU Patent EP0740800 discloses method and apparatus for detecting living bodies based on illuminating the area of interest with a monochromatic radio frequency (RF) signal and processing reflected signal with a separate receiver without direct connection to transmitted signal. The method employs single port mixing process on an non-linear element. This mixing process (multiplication) involves RF signal, reflected from the target along with a portion of transmitted signal coming through the same receive aperture due to reflection from surrounding objects on the propagation path. By means of a sophisticated digital signal processing the components containing respiration and heartbeat signature are separated and displayed as signal peaks on a frequency plot. The method does disclose detection of living bodies without any electrical connection between interrogating signal source (transmitter) and RF processor (receiver), making it attractive for some applications which require a single target illuminator and one or more receivers for greater area coverage. However, the disclosed method is non-coherent in nature, leading to its principal limitations. Among them are inability to detect a living person at positions where signal reflected from the target is 180 degrees out of phase with a portion of transmitted signal coming thru the antenna aperture (zero spots), and inability to evaluate the range to the target.

### SUMMARY OF THE PRESENT INVENTION

It is an object of the present invention to provide a method of detecting vital signs of living bodies which can reliably detect the presence of persons in visually obstructed areas and estimate range to the target while keeping operation frequency reasonably low for a greater penetration thru the obstacles and narrowband nature of the interrogating signal to reduce radio frequency spectrum requirements.

It is a further object of this invention to provide a system to detect presence of living bodies in visually obstructed areas and to estimate range to the target at distances up to approximately 20 meters.

It is a further object of this invention to extend detection coverage area by means of a multistatic system whereas more than one interrogation signal source and/or more than one radio frequency processors with a common or separate signal processing chain can be deployed for detection and ranging in a greater visually obstructed area.

It is still further object of this invention to provide a detection system which can be used in rescue operations, container and vehicle screening, border checks and the like.

It is still further object of this invention to provide a detection system which is immune to RF interference from other similar systems deployed in the area and which minimizes probability of interference to other users of radio spectrum.

### BRIEF DESCRIPTION OF THE DRAWINGS

FIG. 1 is a theoretical relationship between quadrature components in vital signs signature to the return signal and the range to the target to demonstrate its periodic nature.

FIG. 2 is a result of applying a Fast Fourier Transform (FFT) to the demodulated return signal.

FIG. 3 is a block diagram of the demodulator.

FIG. 4 is an output signal at two consecutive values of the interrogating signal, 1292 MHz and 1297 MHz.

FIG. 5 is a Waterfall Diagram (WFD) for five consecutive frequencies of the interrogating signal.

FIG. 6 is a block diagram of the system for detecting vital signs of living bodies according to this invention.

FIG. 7 is a timing diagram of the step frequency interrogating signal.

FIG. 8 is a functional block diagram of the quadrature demodulator.

FIG. 9 is a block diagram of the system for detecting vital signs of living bodies employing frequency hopping interrogating signal.

FIG. 10 demonstrates ranging using a 12-frequency interrogating signal according to current invention.

FIG. 11 represents a single channel (one frequency of 12) waterfall diagram of a real person's breathing and heartbeat at 2 m behind a 27 cm thick brick wall obtained with the same interrogating signal, whereas a test person has held the breathing for approximately 40 seconds for test purposes.

### DETAILED DESCRIPTION OF THE INVENTION

The method of the present invention will be explained in detail for a single frequency monochromatic signal first, followed by further explanations for a step-frequency and slow frequency hopping interrogating signal.

Assuming that a monochromatic interrogating signal of angular frequency ω is directed at the target of interest, the return signal U_{R}, reflected from the target can be represented as

U_{R}(t)=σ₁A sin ω(t−T), (1)

where σ₁ represents aggregate path loss, A is amplitude of the interrogating signal, and parameter T represents round trip time delay.

Quadrature mixing of the return signal U_{R}(t) with the interrogating signal A sin ωt, A cos ωt yields the following output after removing high frequency components:

$${U}_{I} = \frac{1}{2} {σ}_{1} {σ}_{2} cos ω T , \\ {U}_{Q} = \frac{1}{2} {σ}_{1} {σ}_{2} sin ω T , \qquad ( 2 )$$

where σ₂ denotes aggregate conversion loss in splitters and mixers.

For a static target T=const and mixing produces direct current components. Minute movements of a living body's surface due to respiration and heartbeat lead to periodic variations in round trip range R, it becomes time-variant R(t), hence, round trip delay becomes also time variant T(t)=2R(t)/c. Substituting T with 2R(t)/c and ω with 2πc/λ the equations for quadrature components can be written as:

$${U}_{I} ∼ cos \frac{4 π R ( t )}{λ} , \\ {U}_{Q} ∼ sin \frac{4 π R ( t )}{λ} , \qquad ( 3 )$$

where λ denotes interrogating signal wavelength.

For reasonably calm target R(t) can be written as

R(t)=R₀+R_{V}(t), (4)

where R₀—median range to the target
R_{V}(t)—time variable resulting from living body's minute movement due to respiration and heartbeat.

Combining (3) and (4) after simple trigonometrical transformations yields:

$${U}_{I} ∼ cos \frac{4 π }{λ} {R}_{0} cos \frac{4 π }{λ} {R}_{V} ( t ) - sin \frac{4 π }{λ} {R}_{0} sin \frac{4 π }{λ} {R}_{V} ( t ) , \\ {U}_{Q} ∼ \frac{4 π }{λ} {R}_{0} cos \frac{4 π }{λ} {R}_{V} ( t ) + cos \frac{4 π }{λ} {R}_{0} sin \frac{4 π }{λ} {R}_{V} ( t ) , \qquad ( 5 )$$

It can be seen from (5) that quadrature output signals representing information of interest R_{V}(t) are periodical functions of the median range to the target R₀ and at R₀=λ/8, 3λ/8, 5λ/8 etc. R₀=(2k−1)λ/8 (k=1, 2, 3 . . . )

$$\begin{matrix}{U}_{I} ∼ - sin \frac{4 π }{λ} {R}_{V} ( t ) , \\ {U}_{Q} ∼ cos \frac{4 π }{λ} {R}_{V} ( t ) , \\ and at {R}_{0} = 2 k λ / 8 ( k = 1 , 2 , 3 … ) & ( 6 ) \\ {U}_{I} ∼ cos \frac{4 π }{λ} {R}_{V} ( t ) , \\ {U}_{Q} ∼ sin \frac{4 π }{λ} {R}_{V} ( t ) , & ( 7 )\end{matrix}$$

If RF wavelength is much longer than amplitude of the movements associated with respiration and heartbeat, λ>>|R_{V}(t)| cosine term in (6,7) denotes positions where output is at minimum and sine term denotes positions where output is at maximum. For a sign-variable R_{V}(t), say R_{V}=A_{V} sin 2πF_{V}t, where A_{V} and F_{V} are respectively amplitude and frequency of breathing or respiration signature, the cosine term produces no output on the frequency F_{V}, while sine term produces maximum output signal on F_{V}.

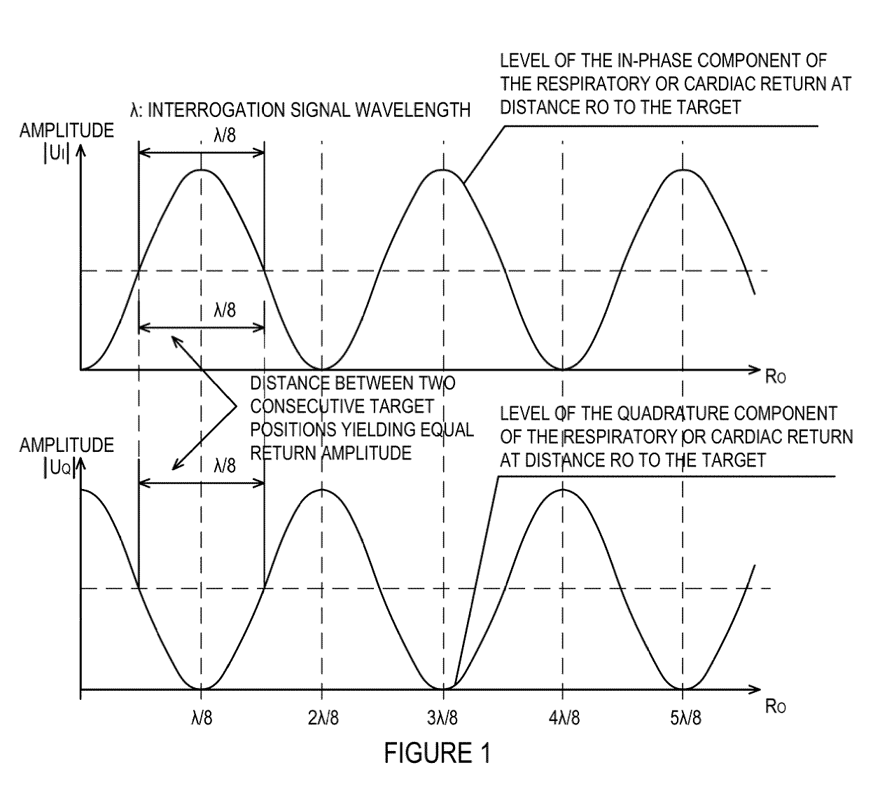

The relationship between U_{I}, U_{Q} and R₀ is represented in FIG. 1. It is seen from FIG. 1 that this relationship is periodic with a period λ/4, and amplitude of both components are equal at R₀=(2k−1)λ/16, k=1, 2, 3 (odd integer sixteenth wavelength), giving distance between two adjacent positions with equal amplitude of I and Q component equal to λ/8.

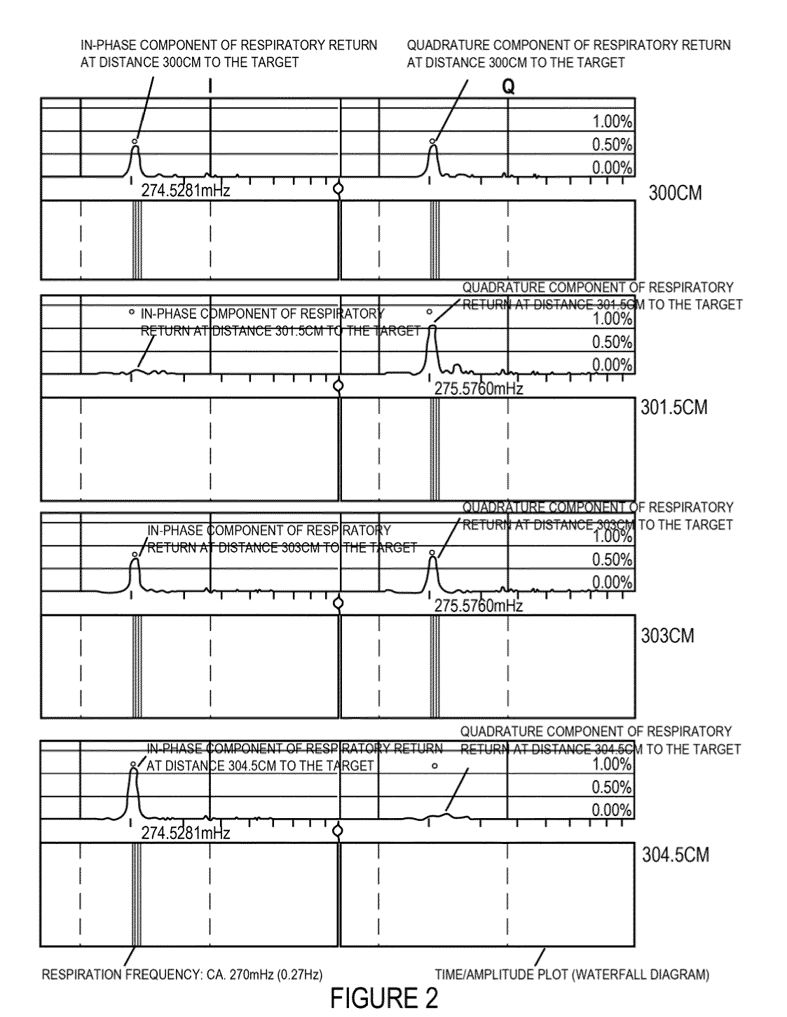

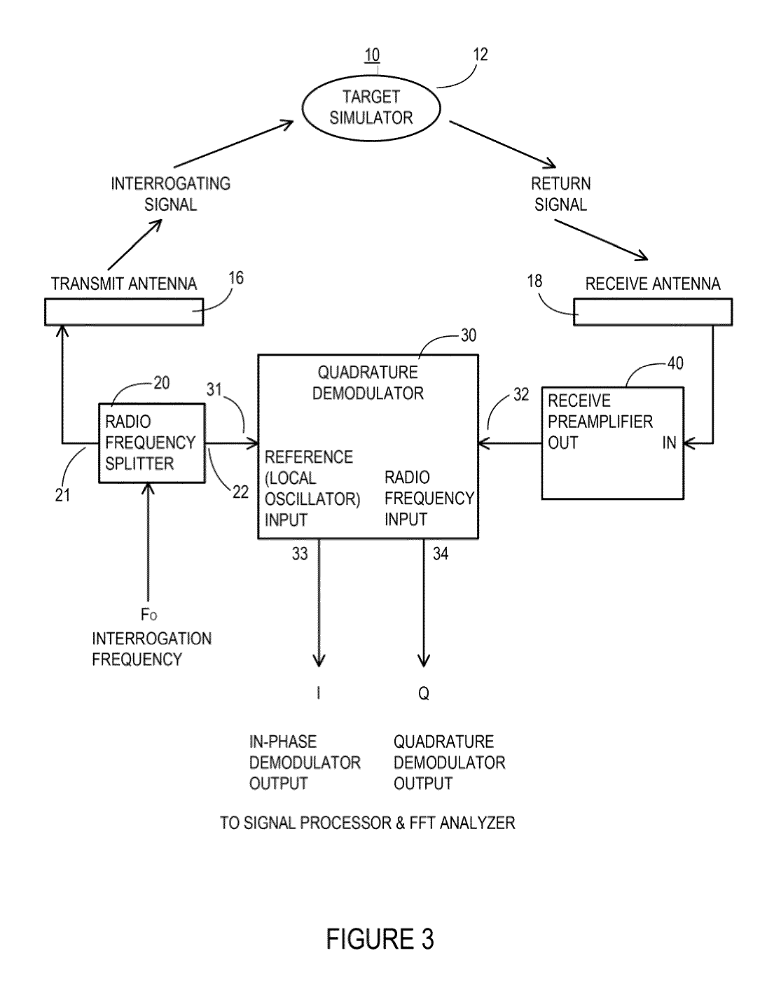

To further explain this relationship FIG. 2 represents experimental results obtained in a set-up as shown in FIG. 3. The measurement set-up 10 includes (1) a target simulator 12 having a radar cross-section (RCS) approximately equal to RCS of a real person to produce a reflected radio frequency (RF) signal containing typical respiration or heartbeat signature, a transmit antenna 16, a receive antenna 18, an RF splitter 20 to produce transmit signal and reference signal at its outputs 21 and 22, a quadrature demodulator 30 to extract the vital sign signature in the return signal by means of multiplication of reference (local oscillator) signal appearing at its reference input 31 and RF signal appearing at its RF input 32 and producing in-phase and quadrature signals on its outputs 33,34, and a radio frequency preamplifier 40 to compensate RF signal attenuation. A membrane breathing simulator with frequency 2.5 Hz placed at a distance approximately 3 m from transmit and receive antennas was used as a signal source. The breathing simulator had a radar cross-section (RCS) approximately equal to that of a human body as referred to breathing signature at 1215 MHz interrogating signal. A 16 bit analog-to-digital converter and a software Fast Fourier Transform (FFT) analyzer were used for monitoring of spectral components in the return signal. Spectral plots and partial waterfall

diagrams (WFD) in FIG. 2 represent demodulated quadrature I & Q signals on breathing frequency (vital signs signature) for several consecutive positions starting from 300 cm. This relationship is used in current invention for distance calibration as a calibrated range measure, although it cannot be used directly for ranging because of unavoidable ambiguity. Electrical shift of target position by way of changing the frequency of the interrogating signal to get absolute distance to the target proposed ranging method employs is used as described below.

Aggregate phase shift of the RF signal depends on its frequency and propagation path length. Thus, any change in propagation path length can be compensated by a frequency shift to maintain the same phase relationship, and accordingly, every frequency shift leads to an equivalent propagation path change. A very simple relationship exists between frequency shift AF and equivalent path change ΔR₀:

$$Δ F = \frac{300}{( λ / Δ R ) {R}_{0}} . \qquad ( 8 )$$

Thus, solving (8) against R₀ yields the range to the target if a required frequency shift ΔF to compensate the known range shift ΔR is known.

Obviously, calculating the range R₀ requires some reference to determine range shift ΔR and some method of measuring the phase relationship in signal path to determine as to whether frequency shift ΔF compensates for range shift.

It would be impractical but still possible to make two or more consecutive measurements of vital sign signature in the return signal while changing position of the antenna with some increment and adjusting the frequency of the interrogating signal until demodulated vital sign signature returns to its initial form (starts repeating itself), and thus obtained frequency shift can be used to calculate the range to the target. If, say initial position of the antenna and initial frequency correspond to maximal respiration signature in the return signal, the must same apply to a new position on the shifted frequency. To avoid range ambiguity the aggregate position shift must be smaller than a quarter of the interrogating signal's wavelength. Changing physical position of the antenna can be substituted by inserting a delay line or a voltage variable phase shifter into transmitter's or receiver's RF path, this would still require absolute measurement in a vital sign signature of the return signal, which are difficult to implement, because the return signal may be highly cluttered.

In the method according to this invention frequency shift which corresponds to two consecutive conditions in the return signal with equal I and Q components is used as a reference for ΔR. As shown above, these two positions are equal to a range shift of λ/8. Solving (8) against R₀ΔR=λ/8 yields

$${R}_{0} = \frac{300}{8 Δ F} . \qquad ( 9 )$$

In a simplest embodiment using a single channel quadrature analysis and a consecutive frequency sequential interrogating signal the following can briefly describe method of detecting vital signs of living bodies according to this invention:

1. An interrogating electromagnetic signal is directed at the region of interest.
2. The reflected energy is phase demodulated in quadrature by means of a homodyne or a heterodyne process using samples of radiated signal as a reference.
3. The quadrature signals so obtained are displayed as spectrum plots and/or waterfall diagrams and analyzed on presence of respiration or heartbeat signature.
4. The ratio of the quadrature signal levels in the vital sign signature of the return signal is stored.
5. Radio frequency of the interrogating signal is incrementally changed in either direction until the stored ratio achieved again on the new frequency.
6. The corresponding frequency shift is calculated.
7. The range to the target is calculated.

From a practical perspective it may be convenient to use as reference points a pair of frequencies where levels of quadrature signals in vital sign signature of the return signal are equal, because this signal balance is easily to intercept either on spectral plot, or on a waterfall diagram, or modified FFT analyzer's software. In this case the system must be brought to I-Q signal balance first, by changing the radio frequency until both quadrature signals are equal. This would be a starting frequency for the ranging. By changing frequency further until new signal balance achieved, the frequency shift and the range to the target can be determined. This embodiment modifies the method according to this invention as follows:

1. An interrogating electromagnetic signal is directed at the region of interest.
2. The reflected energy is phase demodulated in quadrature by means of a homodyne or a heterodyne process using samples of radiated signal as a reference.
3. The quadrature signals so obtained are displayed as spectrum plots and/or waterfall diagrams and analyzed on presence of respiration or heartbeat signature.
4. The radio frequency of the interrogating signal is incrementally changed in either direction until levels of vital signs signatures in both quadrature signals are equal, and thus, a quadrature balance achieved.
5. The value of the frequency is stored.
6. The radio frequency of the interrogating signal is further incrementally changed in the same direction until the quadrature balance achieved again on the new frequency.
7. The corresponding frequency shift is calculated.
8. The range to the target is calculated.

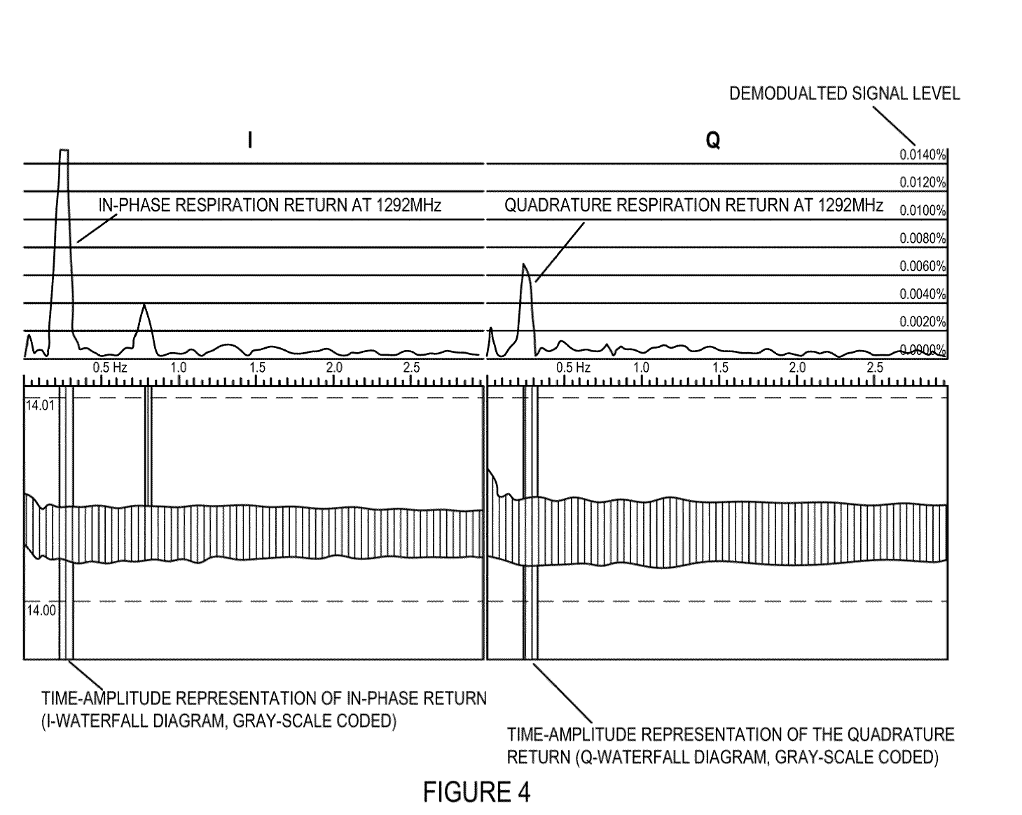

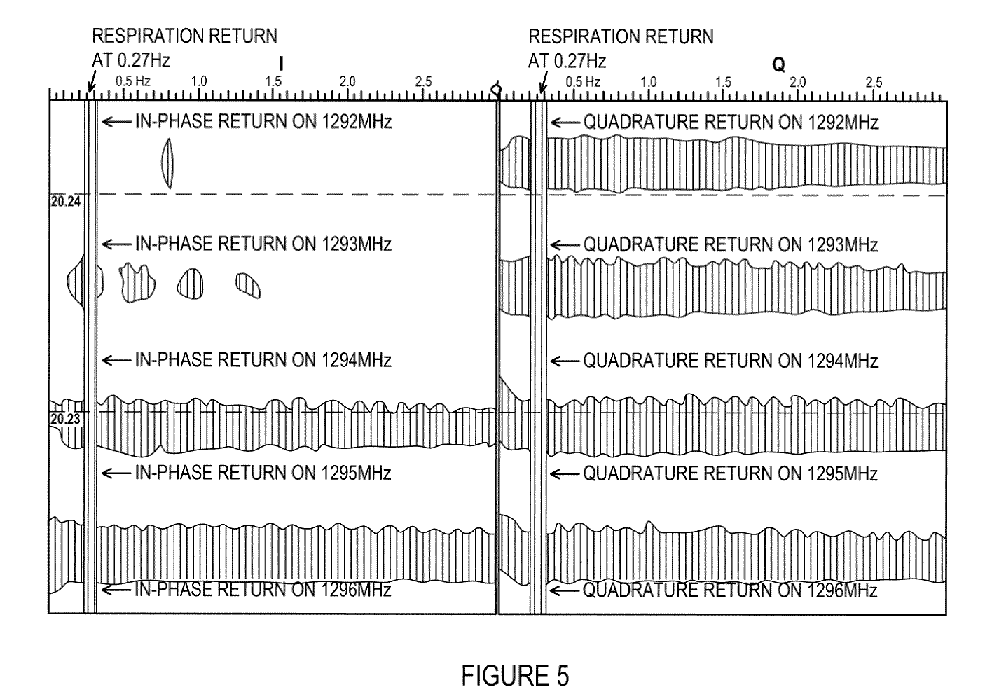

Turning now to FIG. 4 and FIG. 5, which illustrate signal changes by changing the frequency of the interrogating signal. FIG. 4 represents partial WFD and spectral plot corresponding to upper part of WFD for quadrature components in respiration signature when switching the frequency of the interrogating signal from 1292 to 1297 MHz in the same experimental setup shown in FIG. 3. FIG. 5 represents FFT WFD for five consecutive frequencies 1292.5 to 1295.5 MHz with 1 MHz increment.

The exact number of frequencies and frequency increment are determined by required measurement range and ranging tolerance, but as can be seen from equation (9), range reading is inversely proportional to the frequency shift, so the frequency increment must be small enough for a satisfactory ranging at greater distances. For most applications a set of 12 to 15 frequencies will be sufficient. This set of frequencies may be equidistant if application tolerates variable ranging error, or non-equidistant if the same ranging error required within operating range, or if application priorities dictate maximal ranging precision in a certain part of the operation range.

Changing the frequency of the interrogating signal inevitably leads to slower signal acquisition, especially bearing in mind, that the signal of interest, containing information on vital signs lies in the frequency range of 0.1 Hz to 2 Hz. Analyzing return signal on presence of such low frequency components even without averaging or autocorrelation would require at least 10 second, in fact, this would be not possible in all but extremely favorable conditions, when return signal contains no clutters and the system is

not disturbed, hence, a some degree of averaging must be applied, making signal analysis length for every frequency about 60 to 100 seconds. Therefore, development of a detecting system implementing the detection method has been a further focal point of this invention.

The entire set of the operating frequencies for vital signs detection according to the present invention can be incorporated into a composite interrogating RF signal, while a common receive antenna and separate parallel RF processing and quadrature analysis are used for every frequency in the return signal. The same antenna can be used for transmitting interrogating signal, if a high isolation splitter or circulator is employed in the system. The quadrature signals for every frequency can be displayed as a multistrip WFD and multichannel spectral plot, using a commercially available multichannel FFT analyzer. This arrangement poses certain requirements on strong signal handling capability and low level of multisignal intermodulation in RF circuitry, which are, however can be met using modern components and some arrangements minimizing direct feedthru of the interrogating signal into receive antenna.

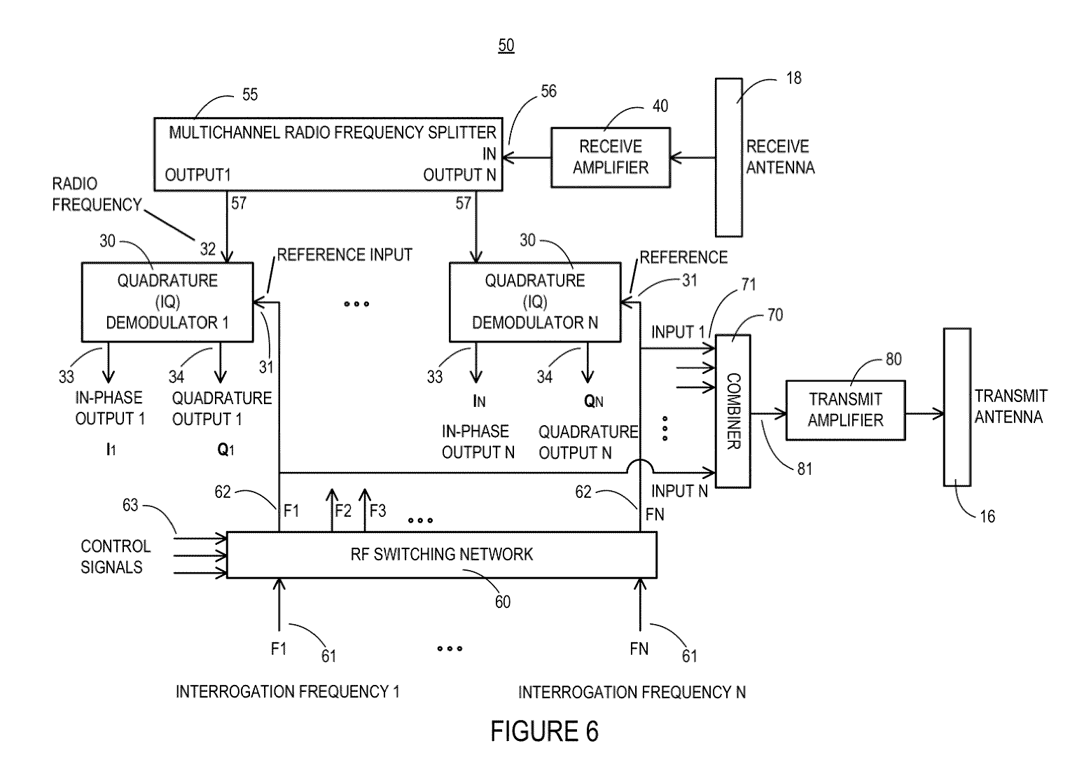

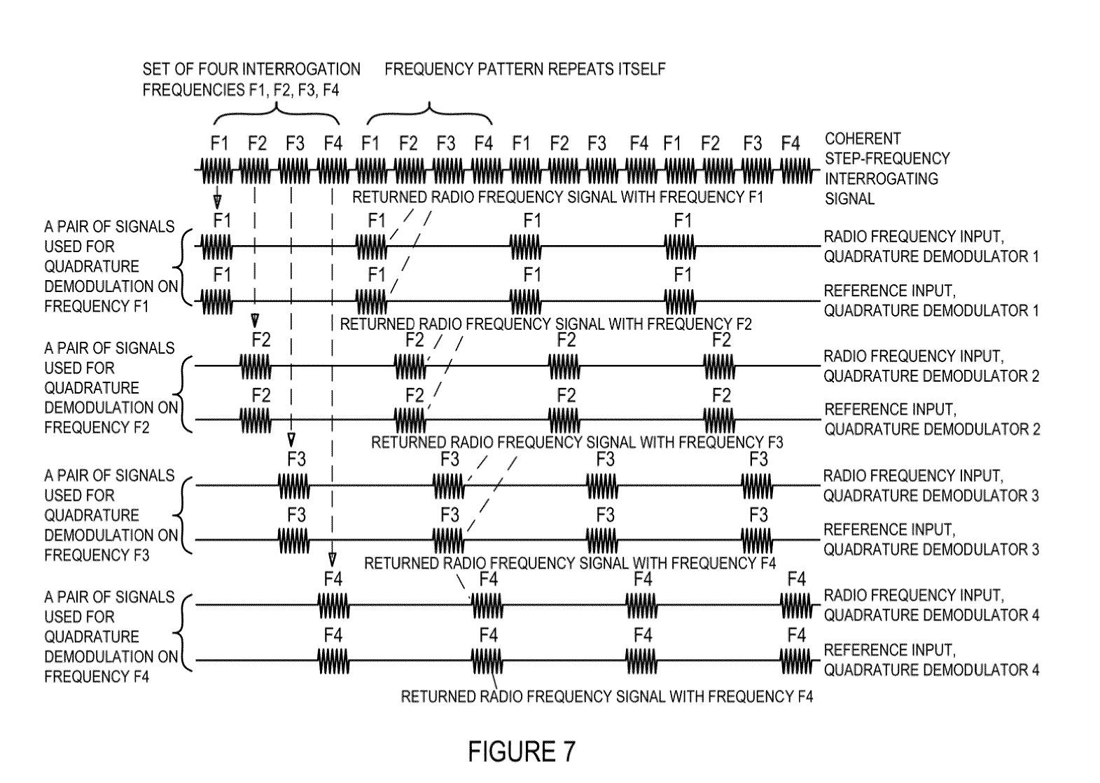

The preferred embodiment of current invention is using a system with a step-frequency interrogating signal, as presented in FIG. 6 and associated timing diagram as presented on FIG. 7. The system (50) according to present invention includes a receive antenna 18, a receive amplifier 40 to compensate for RF path loss, a multichannel radio frequency splitter 55 with a single input 56 and N outputs 57 according to number of interrogation frequencies F₁ . . . F_{N}, each of said outputs is RF input for one of N quadrature demodulators 30, an RF switching network 60 having N RF inputs 61 and N RF outputs 62 according to number of interrogation frequencies, whereas each of its N inputs 61 is connected to a separate continuous wave source of interrogating signal on frequency F₁ . . . F_{N} (not shown), and each of its N outputs 62 is connected to reference input 31 of the oine of N quadrature demodulators 30. RF switching network 60 is controlled thru its control inputs 63. Each of the N RF outputs 62 of RF switching network 60 is connected to corresponding N inputs 71 of the combiner 70 to produce composite interrogating signal at the input 81 of the transmit amplifier 80, whose output is connected to transmit antenna 16. The demodulated signal for extraction of the vital signs on every frequency F₁ . . . F_{N} is derived from in-phase and quadrature outputs 33, 34 of every quadrature demodulator 30.

The system employs a set of discrete frequencies F₁ . . . F_{N} to synthesize a step-frequency interrogating signal. This set of frequencies may be produced by a chain of separate crystal oscillators or by a number of frequency synthesizers with adequate phase coherency and noise properties. The said set of frequencies must be in the form of continuous wave signals to ensure phase continuity on every frequency and interrogating signal integrity.

The RF switching network 60 performs scrambling and demultiplexing of the RF signal on every frequency so that an RF pulse signal on the frequency F1 appears on its first output 62, following an RF pulse signal on the frequency F₂ on its second output, following by RF pulse signal on frequency F₃ on its third output, and so on until a RF pulse signal appears on its last output N on the frequency F_{N}, after that the process cyclically repeats itself. In FIG. 4 this process is shown for a set of four frequencies, although the same applies for any number of frequencies. These output signals of the RF switching network 60 are used as reference signals for quadrature demodulation on every frequency by means of a set of N quadrature demodulators 30, as shown in FIG. 6.

The said output signals of RF switching network are also applied to a combiner 70 to obtain an interrogating signal with consecutive RF pulse frequencies F₁ . . . F_{N} as shown in FIG. 7 for a set of four frequencies. This interrogating signal is further amplified by transmit amplifier 80 and is radiated by means of a transmit antenna 16 as shown in FIG. 6.

The return signal from a receive antenna 18 thru receive amplifier 40 is rooted to Multichannel Radio Frequency Splitter 55. Every signal on its input 56 is equally distributed between its N outputs 57. These output signals are applied separately to RF inputs of quadrature demodulators 30 (1 to N). The Signal at input 32 of every quadrature demodulator 30 contains a set of consecutive RF pulses on all frequencies contained in the interrogating signal. Nevertheless every quadrature demodulator produces I and Q output signals only during those time slots when the reference signal from RF switching network 60 with only one frequency from a set of frequencies F₁ . . . F_{N} applied to this particular quadrature demodulator.

Signals from output 33 (I₁ . . . I_{N}) and 34 (Q₁ . . . Q_{N}) can be further processed with a conventional FFT analyzer may be displayed on a multistrip waterfall diagram, on a multiline spectral plot or on a real time XY plot.

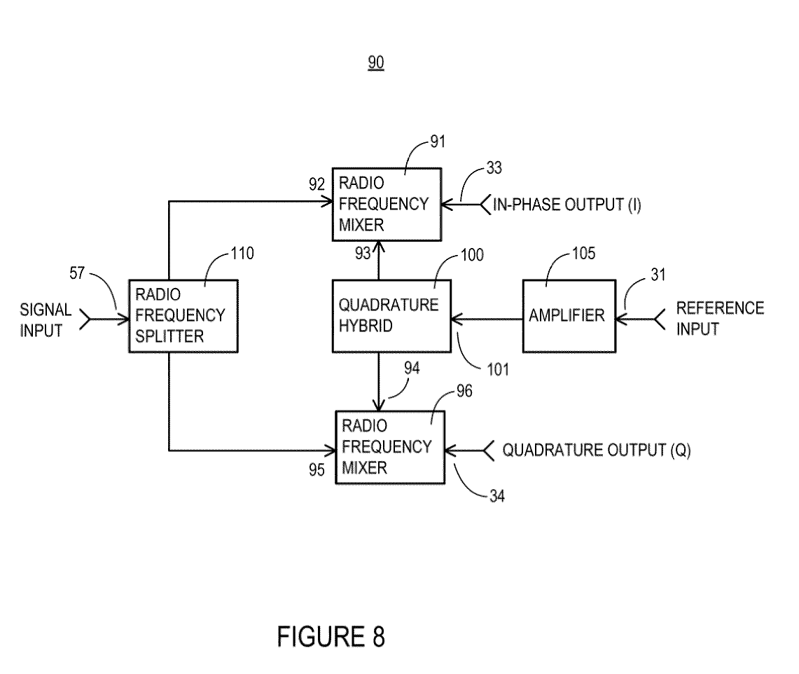

A functional block diagram of the quadrature demodulator is represented in FIG. 8. Quadrature demodulator 90 includes a pair of RF mixers 91, 96, their inputs 93, 94 are fed in quadrature from a quadrature hybrid 100. The reference signal to said quadrature hybrid 100 applied to its input 101 from reference input 31 via an amplifier 105 to ensure a proper reference signal level for RF mixers 91, 96. RF signal from RF input 57 is rooted to RF inputs 92, 95 of the mixers 91,96 through RF splitter 110. The RF input signal thru a Radio Frequency splitter 110 applied to a pair of high level double balanced mixers 91, 96. Quadrature demodulator 90 implements a homodyne conversion of the phase variations in the incoming radio frequency signal into amplitude variation of the quadrature components on its outputs 33,34. Further FFT or spectrum analysis of these signals yields characteristic components associated with heartbeat (typical frequencies 0.8 to 2 Hz) and respiration (typical frequencies 0.15 to 0.3 Hz). Because of a small number of frequencies necessary for vital signs detection and ranging, RF switching network 60 can be built around commercially available RF absorbtive and reflective switchers at frequencies at least up to 4 GHz (e.g. MiniCircuits Ltd). RF switching network may be controlled by a separate microprocessor or by the same computer which performs FFT and signal processing, or even by a simple sequencing circuit. All variants of the RF switching network architecture and its control are obvious to those skilled in the art. Another embodiment of the system for detecting vital signs of living bodies employs a slow frequency hopping interrogating signal. A frequency hopping interrogating signal reduces probability of mutual interference if more than one system is deployed on the site, as it may be the case in a rescue operation, on a border control terminal etc.

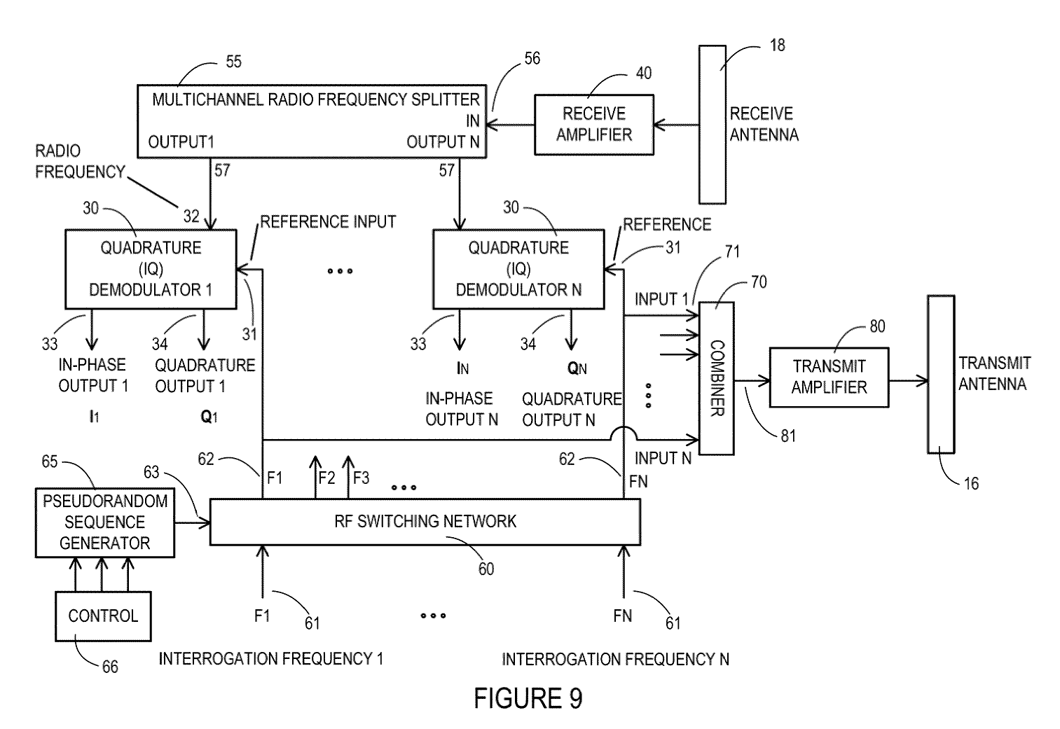

Essentially the same arrangement as represented in FIG. 6 may be used for a slow frequency hopping interrogation signal if the control algorithm is changed. A modified function diagram of the system for detecting vital signs of living bodies according to current invention is represented in FIG. 9. The system according to present invention employing frequency-hopping interrogating signal employs the block diagram of FIG. 6 with added pseudo-random sequence generator 65 to control RF switching network 60. The frequency hopping pattern is determined by a controller 66, which can be implemented as a stand-alone hardware pattern generator or as a computer program. Apart from elements represented in FIG. 6 the modified system employs a hardware or software Pseudorandom Sequence Generator 65 to control the RF switching network.

It should be pointed out, that traditional schemes for step frequency and frequency hopping signal synthesis employing frequency switching in phase locked loops based or direct digital synthesizers would lead to enhancing of the phase noise and reduction of the sensitivity and operation range due to partial lost of self-coherency in interrogating signal.

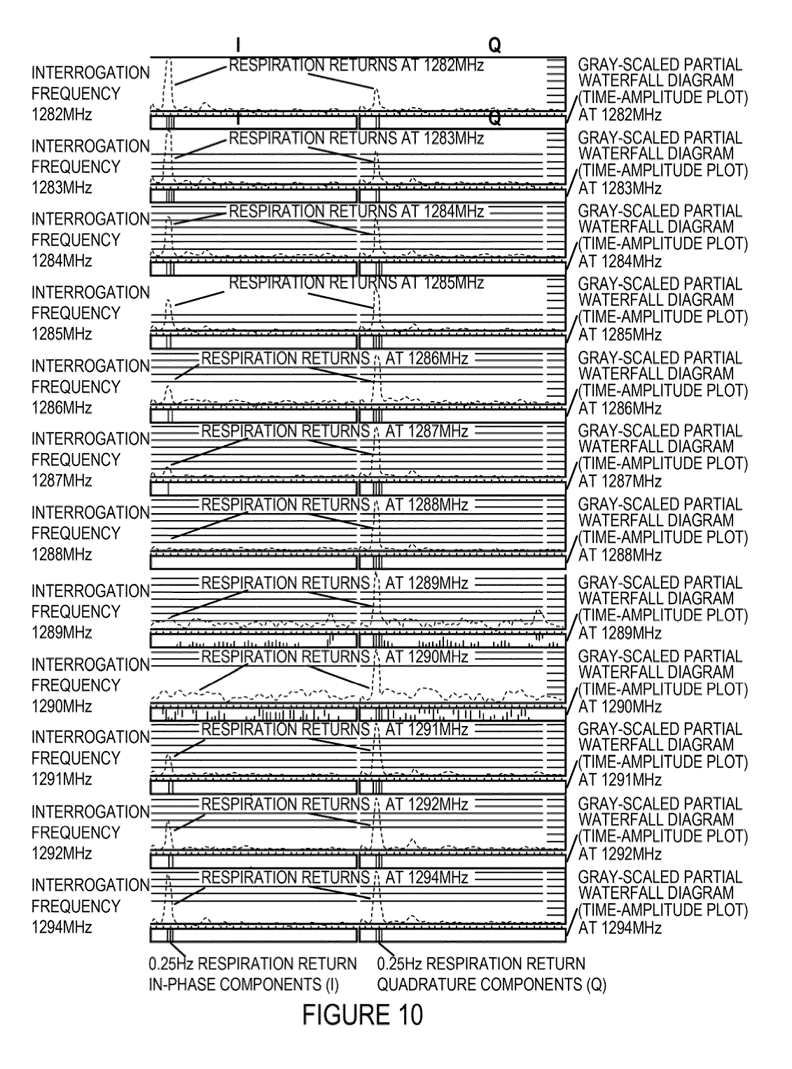

To illustrate measurement of the range to the target, a multistrip partial waterfall diagrams and a multiline spectrum plot represented in FIG. 10 for To illustrate the proposed ranging method a multistrip spectral plot and partial waterfall diagram represented in FIG. 10 for a step frequency interrogating signal spanning 12 frequencies from 1282 to 1294 MHz with frequency step 1 MHz and dwell time 12 ms. As can be seen from FIG. 10 two consecutive frequencies where IQ balance occurs are 1284 MHz and approximately 1294 MHz, corresponding to frequency shift 10 MHz, yielding the range to the target

R₀=300/(8 ΔF)=3.75 m (actual range was 3.5 m).

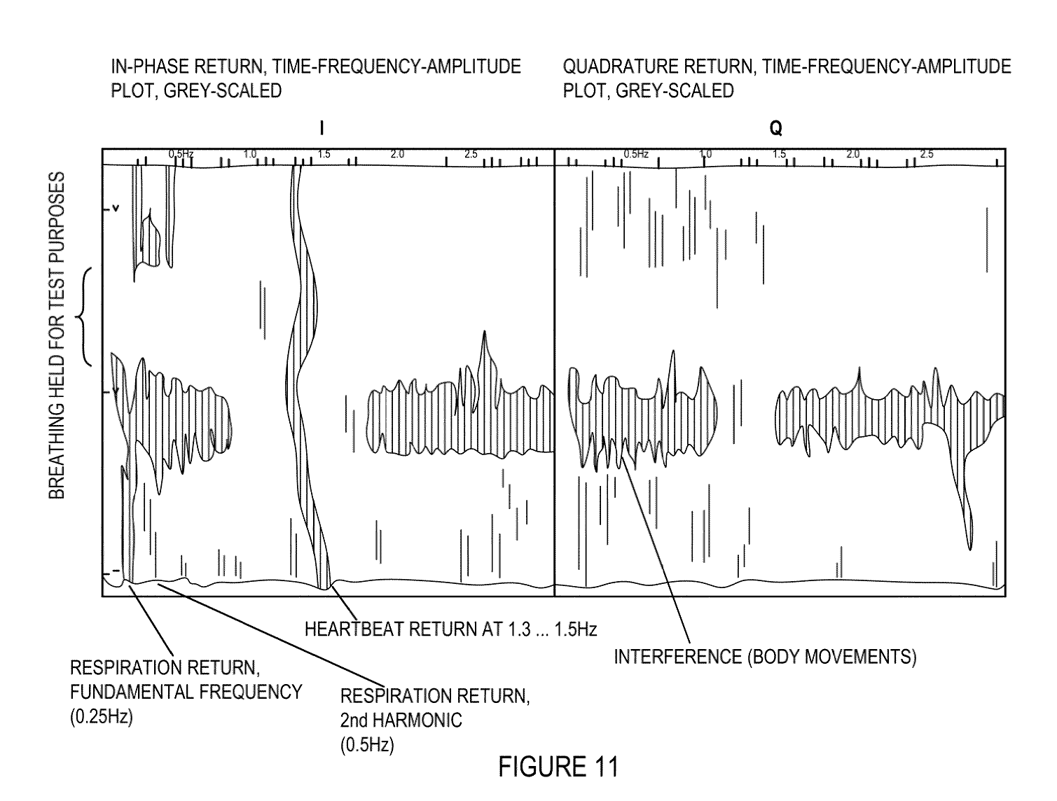

It should be noted, that the range obtained by (9) is an apparent electrical length witch may exceed actual length due to time delay in RF circuitry of the transmitter, receiver and RF cables. These factors can be excluded by a proper calibration of the circuit using RCU. FIG. 11 represents a single channel (one frequency of 12) waterfall diagram of a real person's breathing and heartbeat at 2 m behind a 27 cm thick brick wall obtained with the same interrogating signal.

Fundamental and second harmonic breathing frequency are seen at approximately 0.24 Hz and 0.48 Hz, while a clear heartbeat signal is seen at 1.2 to 1.4 Hz.

Range calibration as it is known in conventional radar technology can not be used for calibration of the proposed method, since only a component containing vital signs signature in return signal is used for ranging, and not reflected RF signal as such, and even not necessarily the strongest component in the return signal. A simple arrangement for range calibration using an arbitrary waveform generator, e.g. TGA1201, a DC-coupled sub-audio amplifier and a loudspeaker, acting as a moving membrane, simulating breathing and heartbeat has been used as an RCU in experiments presented here.

Range reading depends on the propagation media and, since interrogating and return signal propagate though walls, debris and the like, rather than in a free space, a correction coefficients must be integrated into a processing software. And since a very little may be known about electrical properties, some errors are unavoidable. Nevertheless, the proposed method ensures ranging with 20-30% uncertainly, which is adequate for many practical applications.

Apparently, adding ranging capability requires an interrogating signal with more than one frequency in its spectrum, this may require two modes of operation: single-frequency detection and multi-frequency ranging. But even in ranging mode a SF or SFH system, employing a set of a few frequencies requires less RF spectrum resources as compared with a short pulse based systems.

Most operations according to this invention can be implemented using digital signal processing and software signal analysis. Some operations, in fact, require a certain computational power, nevertheless it is well within the power of the up-to date computers, even those in a notebook class. The method of detecting vital signs of living bodies and the system thereof according to this invention can be implemented with minimal hardware even without hardware filters apart from simple RC roofing low pass filters, and the only hardware components required are those shown in FIG. 6. This facilitates technical implementation of the method in the form of a portable light-weight man-pack system, well suited for rescue operations, as a situational awareness system and the like.

While the invention has been described by way of example with respect to a preferred embodiment, it is not limited to this particular embodiment and various modifications and improvements may be made without departing from the essence of this invention, they may be apparent to those skilled in the art. For example, the operating frequency may be optimized with respect to environment where the system deployed to ensure maximal penetration thru the obstructing objects, the number of frequencies, frequency increment, the type of incrementing (equidistant, linear, or non-linear) may be set in accordance to priorities that a particular implementation dictates, e.g. equal ranging error, maximal ranging precision on certain distances etc. The exact type of the interrogating signal—step-frequency, frequency hopping, or multifrequency composite signal—may be dictated by a particular technical implementation and by deployment circumstances, e.g. a multistatic configuration with more than one system on the site may dictate frequency hopping to minimize collisions, a limitation on the peak RF radiated power may lead to use of a composite multifrequency interrogating signal, and when upgrading an existing system a step-frequency signal may be the simplest technical solution to implement. The method according to present invention can be also implemented with a common transmit-receive antenna and a high isolation directional splitter/circulator in a configuration obvious to skilled in the art.

The parameters of the FFT analyzer and of the analog-to digital conferrer can be varied according to necessary dynamic range of the system, and a particular window type for FFT (Henning, Hamming, Rectangular or other) and FFT volume may be chosen according to operator's preferences. The method according to current invention has been described with respect to a multistrip waterfall diagram and spectral plot of the demodulated return signal by way of example only, it would be obvious to those skilled in the art, that many other methods of measurement of the quadrature components, both hardware and software based, can be applied, including full automatic computation of the range to the target, without departing from the scope of current invention. The internal structure of the blocks shown in respective Figures in of the current description may be changed without changing the functionality of the method according to this invention. Accordingly, it is to be understood, that the invention is not limited by the specific illustrative embodiment, but only by the scope of appended claims. A system for detecting vital sings of living bodies includes a means of generating said multifrequency or step-frequency interrogating signal, a transmit antenna, a receive antenna, a multichannel quadrature mixer and multichannel FFT analyzer. The quadrature components so obtained can be processed jointly or separately and monitored on a multistrip waterfall diagram or as a multichannel spectrum plot.

I claim:

1. A method for detecting vital signs of living bodies in particular in visually obstructed areas comprising:
illuminating an area of interest with penetrating electromagnetic energy and analysis of a reflected energy on presence of vital signs using a part of radiated energy as a reference; a multifrequency continuous wave or step-frequency pulse interrogating electromagnetic signal is directed at the area of interest, the reflected energy is phase demodulated in quadrature separately on every frequency component by means of separate homodyne or heterodyne process using samples of corresponding frequency components of radiated signal as a reference, quadrature signals so obtained are analyzed on presence of respiration and heartbeat signature, whereby pairs of frequencies with the same relationship of quadrature components in respiration or heartbeat signature are used for ranging; and
detecting vital signs of living bodies includes a means of generating said multifrequency or step-frequency interrogating signal, a transmit antenna, a receive antenna, a multichannel quadrature mixer and multichannel FFT analyzer, the quadrature components so obtained can be processed jointly or separately and monitored on a multistrip waterfall diagram or as a multichannel spectrum plot.

2. The method of claim 1 wherein a range to the target is calculated as R=300/(8F), where F is a difference between two adjacent interrogation frequencies yielding equal relationship of quadrature components in respiration or heartbeat signature.

3. A device for detecting vital signs of living bodies in particular in visually obstructed areas comprising:
a means of illuminating the area of interest with penetrating electromagnetic energy and analysis of the reflected energy on presence of vital signs using a part of radiated energy as a reference:
a multifrequency continuous wave or step-frequency pulse interrogating electromagnetic signal is directed at the region of interest, the reflected energy is phase demodulated in quadrature separately on every frequency component by means of separate homodyne or heterodyne process using samples of corresponding frequency components of radiated signal as a reference, the quadrature signals so obtained are analyzed on presence of respiration and heartbeat signature, whereby pairs of frequencies with the same relationship of quadrature components in respiration or heartbeat signature are used for ranging, a system to detect vital signs of living bodies includes a means of generating said multifrequency or step-frequency interrogating signal, a transmit antenna, a receive antenna, a multichannel quadrature mixer and multichannel FFT analyzer, the quadrature components so obtained can be processed jointly or separately and monitored on a multistrip waterfall diagram or as a multichannel spectrum plot.

4. A method for detecting vital signs of living bodies in particular in visually obstructed areas comprising:
directing an interrogating electromagnetic signal at a region of interest to produce a reflected energy;
providing the reflected energy with phase demodulated in quadrature by means of a homodyne or a heterodyne process using samples of radiated signal as a reference;
displaying the quadrature signals so obtained as a selected one of spectrum plots, waterfall diagrams, spectrum plots and waterfall diagrams and analyzed on presence of respiration or heartbeat signature;
storing a ratio of quadrature signal levels in a vital sign signature of a return signal;
changing incrementally a radio frequency of the interrogating signal in either direction until a stored ratio achieved again on a new frequency;
calculating a corresponding frequency shift; and
calculating a range to a target as R=300/(8F) where F is the frequency shift.
